(19) United States
(12) Patent Application Publication
(10) Pub. No.: US 2010/0270455 A1
(43) Pub. Date: Oct. 28, 2010

(54) Device for Locking a Vehicle Seat

(75) Inventor: Johannes Obrecht, Oberkirch (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: PROGRESS-WERK OBERKIRCH AG, Oberkirch (DE)

(21) Appl. No.: 12/766,566

(22) Filed: Apr. 23, 2010

(30) Foreign Application Priority Data
Apr. 24, 2009 (DE) 10 2009 019 510.6

(51) Int. Cl. F16B 2/10

(52) U.S. Cl. 248/503.1

(57) ABSTRACT

A device for locking a vehicle seat comprises a locking pawl which may be pivoted about a first pivot axis, and which is in engagement with a fitting part in a closed position and is released from the fitting part in an open position, and a locking element which may be pivoted about a second pivot axis, the locking element, in a first pivoted position being in contact with the locking pawl and clamping said locking pawl into the closed position, and in a second pivoted position releasing the locking pawl, so that the locking pawl may adopt its open position. The locking element is additionally movable in a translatory manner, and a clamping element is associated with the locking element, which moves the locking element in the first pivoted position thereof in a translatory manner increasingly against the locking pawl until the locking pawl is clamped into the closed position.

### CROSS REFERENCE TO FOREIGN APPLICATION

The present application claims priority of German patent application No. 10 2009 019 510.6 filed on Apr. 24, 2009.

### BACKGROUND OF THE INVENTION

The invention generally relates to devices for locking vehicle seats. More specifically, the invention relates to a device for locking a vehicle seat, which may be used for anchoring a vehicle seat to the floor of the vehicle or for locking a pivotable backrest of a vehicle seat. Such a device for locking a vehicle seat generally comprises a locking pawl which can be brought in engagement with a fitting part, and a locking element which clamps the locking pawl into a closed position in order to clamp the locking pawl in engagement with the fitting part.

The fixed fitting part, with which the locking pawl is in engagement in its closed position, in the case of use of the locking device for anchoring a vehicle seat to the floor is, for example, a bolt fixed to the bodywork, which is encompassed by a jaw of the locking pawl in the closed position thereof. The locking element is used to clamp and to lock the pivotable locking pawl into its closed position. In the case of use of the locking device for locking a pivotable backrest of a vehicle seat, the fixed fitting part is, for example, a bolt fastened to the lower seat frame, whilst the locking device is mounted on the pivotable backrest.

Various requirements are set for such locking devices.

A first requirement is that the locking pawl, during operation of the vehicle in which the vehicle seat is installed, is not able to open automatically. In the event of an impact of the vehicle during an accident, however, high forces may act on the locking pawl which may exert on the locking pawl a torque in the direction of its open position. The locking element has to counteract such an opening moment, in order to hold the locking pawl securely in its closed position. This may be achieved, for example, by the locking element being in contact with the locking pawl in the closed position thereof by self-locking of the bearing surfaces on both sides.

The second requirement for such a locking device is that it may be easily actuated for intentional opening of the locking pawl. The previously mentioned self-locking of the bearing of the locking element on the locking pawl may, however, counteract such a smooth-running actuation of the locking element for opening the locking pawl.

In the locking device according to DE 44 39 644 C2 the locking element is provided with a clamping surface which, with regard to the pivot axis of the locking element, has such a high degree of eccentricity that the clamping surface of the locking element bears without self-locking against the clamping surface of the locking pawl. The absence of self-locking between the clamping surface of the locking element and the clamping surface of the locking pawl, however, in the event of a vehicle impact causes the clamping surface of the locking element to slip off the clamping surface of the locking pawl. In order to prevent the locking pawl in such a case from reaching its open position, the locking element additionally has a catching surface which is configured such that it extends parallel to a displacement path between an axis of curvature of the clamping surface of the locking element and the pivot axis of the locking element. The catching surface is accordingly a planar surface with a 0° gradient relative to the pivot axis of the locking element.

According to a further exemplary embodiment in DE 44 39 644 C2, the catching surface is configured on a separate catching element.

The embodiment of the known locking device comprising a locking element which has a clamping surface, which bears without self-locking against a clamping surface of the locking pawl, also has the drawback that in order to compensate for play so as to avoid rattling of the device during operation, a sufficiently large counter force always has to be produced in order to keep the device, i.e. more specifically the locking pawl, closed, which has to be implemented, for example, by a sufficiently high spring force.

### SUMMARY OF THE INVENTION

An object of the invention is to develop a device for locking a vehicle seat of the aforementioned type so that it fulfills the requirements for impact safety, that it may be easily actuated and the locking pawl is clamped in its closed position in such a manner that rattling noise is avoided.

According to the present application, a device for locking a vehicle seat is provided, comprising

a locking pawl,

a first pivot axis about which the locking pawl is pivotable between a closed position and an open position,

a locking element,

a second pivot axis about which the locking element is pivotable between a first pivoted position and a second pivoted position, the locking element being in contact with the locking pawl and clamping the locking pawl into the closed position in the first pivoted position, and the locking element releasing the locking pawl in the second pivoted position so that the locking pawl may adopt the open position, the locking element further being additionally movable in a translatory manner, and

a clamping element associated with the locking element, the clamping element moving the locking element in the first pivoted position of the locking element in said translatory manner increasingly against the locking pawl until the locking pawl is clamped into the closed position.

The locking device disclosed in DE 44 39 644 C2 is based on the concept of designing the locking element exclusively in a pivotable manner, which is why a clamping surface has to be provided on the locking element for exerting a clamping force on the locking pawl, which extends from a starting portion corresponding to the smallest adjustable amount of clamping of the locking pawl to an end portion corresponding to the largest adjustable amount of clamping, i.e. the clamping surface requires an eccentricity relative to the pivot axis of the locking element. If such a clamping surface without self-locking is intended to be in contact with the locking pawl, accordingly the catching surface is also required in the known device which, in the event of a vehicle impact, prevents opening of the locking pawl.

The devices according to the instant application, however, depart from the concept of an exclusively pivotable locking element, by the locking element being additionally movable in a translatory manner, and by a clamping element being provided for the locking element, which moves the locking element for clamping the locking pawl in the closed position thereof in a translatory manner increasingly against the locking pawl when the locking element has reached its first pivoted position. The locking element thus performs a pivoting movement and a translatory movement transverse to the second pivot axis between the open position and the closed position of the locking pawl. The locking element thus does not require a clamping surface, extending from a starting portion corresponding to the smallest adjustable amount of clamping of the locking pawl to an end portion corresponding to the largest adjustable amount of clamping, which bears against the locking pawl. The clamping forces on the locking pawl, by which rattling noises are avoided during the operation of the vehicle, are applied by the translatory movement of the locking element. In the device according to the invention the pivoting movement and the translatory movement of the locking element may advantageously be produced solely by the clamping element, as is provided in preferred embodiments which are disclosed hereinafter.

The combination of the clamping element and the locking element also ensures the necessary safety against opening of the locking pawl in the event of an impact. To this end, for increasing the impact safety it is preferably provided that the direction of the translatory movement of the locking element in the first pivoted position extends parallel to a straight line through the second pivot axis and the bearing surface of the locking pawl, against which the locking element bears in the first pivoted position.

The principle according to the invention, according to which the clamping of the locking pawl into the closed position is effected by a translatory movement of the locking element, is advantageously suitable both for an embodiment in which the locking element exerts by its translatory movement a pushing force on the locking pawl in order to clamp said locking pawl into the closed position, and for an embodiment in which the locking element exerts a pulling force on the locking pawl which clamps the locking pawl into the closed position.

Thus, for the first aforementioned case it is provided in a preferred embodiment that the clamping element pushes the locking element in the first pivoted position in a translatory manner against the locking pawl, for example against a region of the locking pawl which is located on the side of the first pivot axis remote from the fitting part.

In this case the clamping element pushes the locking element in a translatory manner increasingly against the locking pawl until the locking pawl is clamped into the closed position.

In an alternative preferred embodiment, the clamping element pulls the locking element in the first pivoted position in a translatory manner against the locking pawl, for example against a region of the locking pawl which is located on the side of the first pivot axis facing the fitting part. In this case, by the translatory movement of the locking element caused by the clamping element, a pulling force is exerted on the locking pawl, for example in the region of its engagement with the fitting part, which securely clamps the locking pawl into its closed position.

In a further preferred embodiment, the direction of the translatory movement of the locking element in the first pivoted position runs substantially perpendicular to a bearing surface of the locking pawl, against which the locking element bears in the first pivoted position.

In this connection, it is advantageous if the locking element due to its translatory movement exerts on the locking pawl a maximum torque about the pivot axis of the locking pawl, whereby the locking pawl is clamped with high force into its closed position and thus rattling noise is avoided as far as possible. Moreover, the force required by the clamping element on the locking element for producing the translatory movement is lower and/or the force exerted by the clamping element on the locking element is optimally utilized.

The locking element may have a bearing surface which may be reduced to a bead-like projection on the locking element. Alternatively, the bearing surface of the locking pawl may be reduced to a bead-like projection. The advantage therein is that the locking element always bears at a defined point against the locking pawl and rolling effects of the locking element on the locking pawl are avoided as, when clamping the locking pawl into its closed position, said locking pawl still pivots slightly about the first pivot axis.

In a further preferred embodiment, the locking element bears in the clamped state of the locking pawl in a self-locking manner against the locking pawl.

In this connection, it is advantageous that in the clamped state of the locking pawl any play of the locking element relative to the locking pawl is avoided even more reliably. The self-locking, however, does not lead to a failure of the locking device to move freely when unlocking the locking pawl as, for unlocking the locking pawl, the locking element is initially moved away from the locking pawl in a translatory manner, whereby no frictional forces occur at the contact point of the locking element with the locking pawl during this process, as is the case in the known locking device in which the locking element is brought out of engagement with the locking pawl by a pivoting movement.

In a further preferred embodiment, the clamping element may also be pivoted about the second pivot axis, the clamping element, proceeding from the second pivoted position as far as the first pivoted position of the locking element, being able to be pivoted substantially together with the locking element and a further pivoting of the clamping element beyond the first pivoted position being converted into the translatory movement of the locking element.

According to this embodiment, the translatory movement of the locking element when reaching the first pivoted position is derived from a further continued pivoted movement of the clamping element, which has the advantage of the locking device being able to be manipulated easily when opening the locking pawl, as the clamping element only has to be pivoted about the second pivot axis for opening the locking pawl, whereby the locking element carries out in succession a translatory movement away from the locking pawl and then a pivoting back into the second pivoted position.

In a further preferred embodiment, a stop is present for the locking element, which prevents a further pivoting of the locking element beyond the first pivoted position.

This measure has, in particular in combination with the aforementioned measure, the advantage that the first pivoted position in which the locking element is moved in a translators manner against the locking pawl is always well defined.

In a further preferred embodiment, in the first pivoted position the locking element is movable radially relative to the second pivot axis in a translatory manner.

This measure has the advantage of a structurally simple mounting of the locking element on the pivot axis of the locking element, this mounting permitting both a pivoting and a translatory movement of the locking element in a defined manner.

In a further preferred embodiment, an axial bearing defining the second pivot axis is associated with both the locking element and the clamping element, the locking element being mounted on the axial bearing with radial play along a straight line.

This measure has the advantage that for the locking element and the clamping element only one axial bearing is required overall, in order to permit the different movement sequences of the clamping element and the locking element and, in particular, the relative movement between the locking element and the clamping element. By means of the radial play of the locking element along a straight line relative to the axial bearing, the direction of the translatory movement of the locking element in the second pivoted position is also well defined which, in particular, further contributes to the impact safety of the device.

In a further preferred embodiment, the locking element and the clamping element are coupled together via a restricted guidance, which permits a defined pivoting movement of the locking element and a translatory movement of the locking element relative to the clamping element.

A coupling of the locking element and the clamping element via a restricted guidance has the advantage that for opening the locking pawl only an actuation of the clamping element is required in order to produce the movement sequences of the locking element, as the movement sequences of the locking element are derived solely from the movement sequence of the clamping element, from the restricted guidance. The clamping element is to this end preferably designed to be exclusively pivotable, so that the movement sequences of the locking element are derived solely from the pivoting movement of the clamping element via the restricted guidance.

In a structurally advantageously simple design, the restricted guidance has a pin-slot arrangement, the slot being curved eccentrically relative to the second pivot axis.

The slot may, for example, be provided on the clamping element and the pin correspondingly on the locking element, or vice versa. By means of the eccentric curvature of the slot, the translatory movement of the locking element is produced with a pivoting of the clamping element about the second pivot axis.

In this connection, the pin-slot arrangement is preferably arranged on the side of the second pivot axis remote from the locking pawl, at a distance therefrom.

This positioning of the pin-slot arrangement relative to the second pivot axis has the advantage of a high degree of lever action of the clamping element on the locking element for producing the translatory movement of the locking element and a high clamping force on the locking pawl, in order to clamp said locking pawl into the closed position In an alternative embodiment, the pin-slot arrangement may also be arranged on the side of the second pivot axis facing the locking pawl.

In a further preferred embodiment, the restricted guidance has an arrangement having a front face of the clamping element which is eccentrically curved relative to the second pivot axis and has a pin arranged on the locking element.

This embodiment also has the advantage of a structurally simple design, the mechanical production of the clamping element with an eccentrically curved front face being even simpler structurally relative to a slot.

Within the context of the aforementioned embodiment, the restricted guidance is arranged on the side of the second pivot axis facing the locking pawl at a distance therefrom.

Also in this embodiment, advantageous lever ratios are produced by the transmission of force from the clamping element onto the locking element for producing the translatory movement for clamping the locking pawl into the closed position.

In a further preferred embodiment, the clamping element is connected to the locking pawl via a resilient element, which exerts on the locking pawl a pretensioning acting in the direction of the open position and a pretensioning acting on the clamping element in the direction of the first pivoted position.

In this case, it is advantageous that, on the one hand, the clamping element in the closed position of the locking pawl is secured against undesired pivoting back into the second pivoted position. On the other hand, the desired open position of the locking pawl is also secured in this manner.

In a further preferred embodiment, the locking element is pretensioned in the direction of the first pivoted position.

Also, in this connection, the operational safety of the locking device is increased as the closed position of the locking pawl is additionally secured by the pretensioning of the locking element in the direction of the first pivoted position.

In a further preferred embodiment, the locking element and/or the clamping element secure the open position of the locking pawl in the second pivoted position.

In this connection, it is advantageous if the locking device remains in the open state after an intentional opening of the locking pawl, until the device is deliberately transferred into the closed position.

In a further preferred embodiment, the clamping element is configured as an actuating element for transferring the locking pawl from the closed position into the open position.

In this connection, it is advantageous if the clamping element in addition to the function of the clamping of the locking pawl in the closed state also has the function of being used as an actuating element for opening the device.

Further advantages and features are revealed from the following description and accompanying drawings.

It is understood that the aforementioned features and the features to be described below in further detail may be used not only in the respective combination provided but also in other combinations or separately, without departing from the scope of the present invention.

### BRIEF DESCRIPTION OF THE DRAWINGS

Embodiments of the invention are shown in the drawings and are described in more detail with reference thereto hereinafter, in which:

FIG. 1 shows a device for locking a vehicle seat in a first operating position in which a locking pawl of the device is in its open position;

FIG. 2 shows the device in FIG. 1 in a further operating position in which, proceeding from its open position, the locking pawl has moved one stage further in the direction of its closed position;

FIG. 3 shows the device in FIG. 1 in a further operating position, in which the locking pawl has moved one stage further in the direction of its closed position;

FIG. 4 shows the device in FIG. 1 in a further operating position, in which the locking pawl is in the same position as in FIG. 3, a locking element and a clamping element of the device having been pivoted from a second pivoted position according to FIGS. 1-3 one stage further in the direction of a first pivoted position;

FIG. 5 shows the device in FIG. 1 in a further operating position in which the locking element and the clamping element are together pivoted into the first pivoted position;

FIG. 6 shows the device in FIG. 1 in a further operating position in which the clamping element is pivoted relative to the locking element beyond the first pivoted position;

FIG. 7 shows the device in FIG. 1 in a further operating position in which the locking pawl is clamped into its closed position;

FIG. 8 shows a device for locking a vehicle seat according to a further exemplary embodiment, a locking pawl of the device being located in its open position;

FIG. 9 shows the device in FIG. 8 in an operating position in which the locking pawl is clamped into its closed position;

FIG. 10 shows a device for locking a vehicle seat according to a further exemplary embodiment, a locking pawl of the device being located in its open position;

FIG. 11 shows the device in FIG. 10 in a further operating position in which the locking pawl, proceeding from its open position, has moved one stage further in the direction of its closed position;

FIG. 12 shows the device in FIG. 10 in a further operating position in which the locking pawl has moved one stage further in the direction of its closed position and a locking element and a clamping element of the device being pivoted from a second pivoted position according to FIGS. 10 and 11 into a first pivoted position;

FIG. 13 shows the device in FIG. 10 in a further operating position in which the clamping element is pivoted relative to the locking element beyond the first pivoted position; and

FIG. 14 shows the device in FIG. 10 in a further operating position in which the locking pawl is clamped into its closed position.

### DETAILED DESCRIPTION OF PREFERRED EXEMPLARY EMBODIMENTS

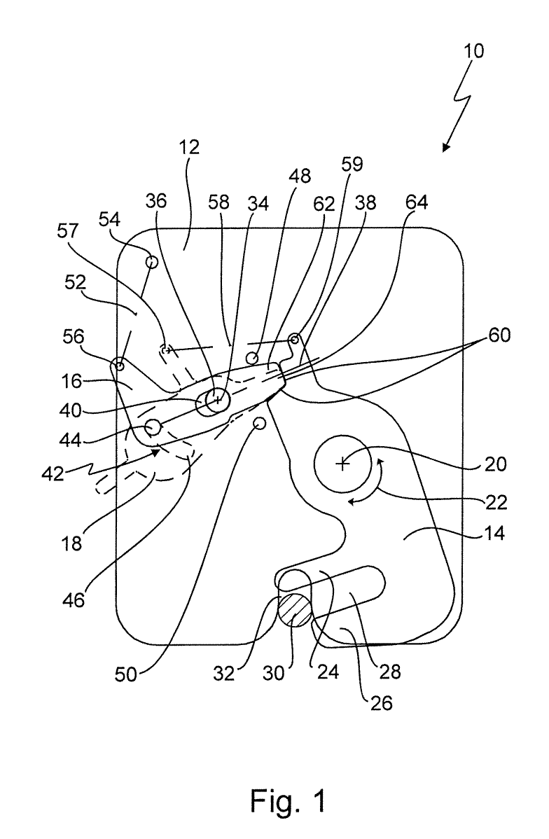

In FIGS. 1-7, a device for locking a vehicle seat is shown provided with the general reference numeral 10. The device 10 serves, in particular, for locking a vehicle seat to the floor of a vehicle.

FIG. 1 shows the device 10 in its open position. Initially the individual components of the device 10 are described with reference to FIG. 1.

The device 10 has a housing 12 which, for example, is fastened to the end of a vehicle seat on the floor side. A locking pawl 14, a locking element 16 and a clamping element 18 are secured to the housing 12, the locking pawl 14, the locking element 16 and the clamping element 18 being held on the housing 12, in a movable manner relative to the housing 12, as is further revealed from the following description.

The locking pawl 14 is able to be pivoted about a first pivot axis 20 according to a double arrow 22. The pivot axis 20 is fixed to the housing, i.e. always maintains its position relative to the housing 12 irrespective of the pivoted position of the locking pawl 14.

The locking pawl 14 has a jaw 28 formed between two fork limbs 24 and 26, which is configured for being engaged with a fitting part 30. The fitting part 30 is, for example, a bolt present on the floor of a vehicle. The housing 12 has a recess 32 into which the fitting part 30 may engage, as shown in FIG. 1.

In the open position of the device 10 shown in FIG. 1 the locking pawl 14 is released from the fitting part 30, so that the device 10 may be removed from the fitting part 30.

The locking element 16 and the clamping element 18 are secured to the housing 12 in a superimposed arrangement. To be able to distinguish the clamping element 18 more clearly from the locking element 16, the clamping element 18 is shown by dotted lines in FIGS. 1-7.

The locking element 16 and the clamping element 18 are mounted pivotably on the housing 12 about a common second pivot axis 34. The second pivot axis 34 is also configured fixed to the housing, and is, for example, defined by an axial bearing 36 fixed to the housing.

Whilst the clamping element 18 is only able to carry out pivoting movements about the second pivot axis 34, the locking element 16 may carry out both pivoting movements about the second pivot axis 34 and translatory movements radially to the second pivot axis 34 along a straight line 38. In order to permit such a translators movement along the straight line 38, the locking element 16 is mounted on the axial bearing 36 with radial play, said radial play being able to be produced by a slot 40 in the locking element 16, which in the direction of the straight line 38 has a larger dimension than the axial bearing 36, but in the direction perpendicular to the straight line 38 has substantially the same or only a slightly larger dimension than the axial bearing 36.

The clamping element 18 is, however, only pivotably mounted on the axial bearing 36 relative to the second pivot axis 34.

The locking element 16 and the clamping element 18 are coupled together via a restricted guidance 42, which has a pin-slot arrangement, a pin 44 which is fixedly connected to the locking element 16 engaging in a slot 46 in the clamping element 18. The restricted guidance 42 serves, as further described below, to derive a translatory movement of the locking element 16 from a pivoting movement of the clamping element 18 about the second pivot axis 34. The restricted guidance 42 is arranged on the side of the second pivot axis 34 remote from the locking pawl 14.

Moreover, two stops 48 and 50 are associated with the locking element 16, which define the pivoting path of the locking element 16 about the second pivot axis 34 in both pivoting directions.

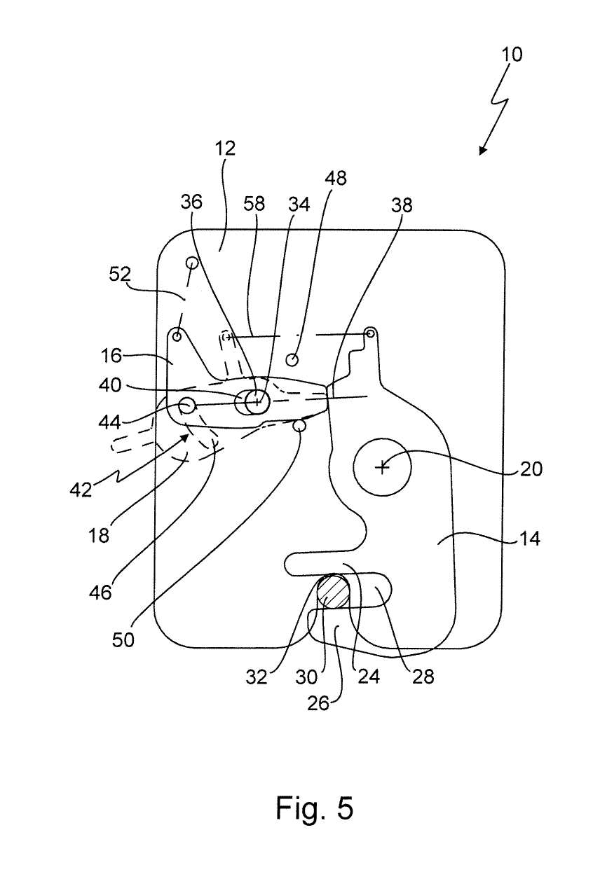

The locking element 16 is further pretensioned via a resilient element 52 which, for example, is configured as a tension spring, one end thereof being fastened to a point 54 fixed to the housing and the other end thereof being fastened to a point 56 on the locking element 16, and namely from the second pivoted position of the locking element 16 shown in FIG. 1 clockwise in the direction of a first pivoted position of the locking element 16 which is shown in FIGS. 5-7.

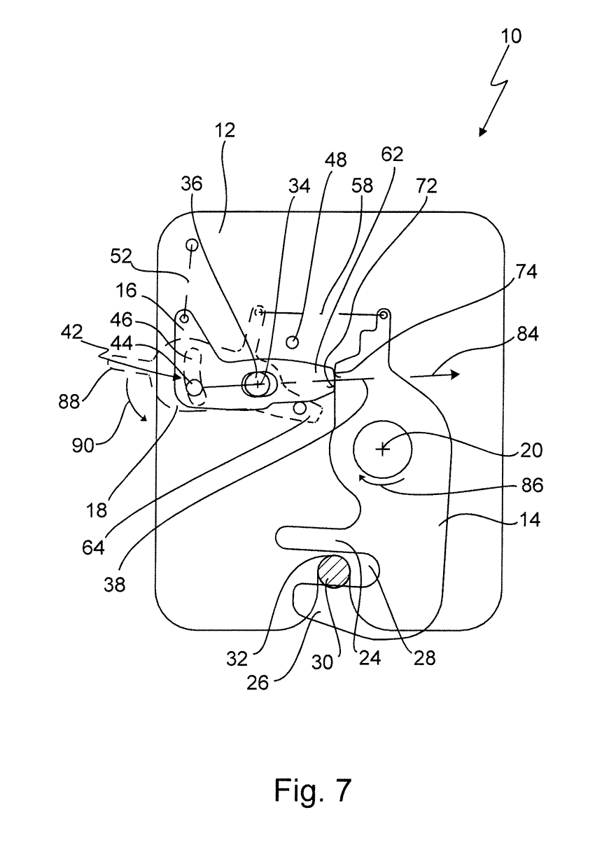

The clamping element 18 is connected to the locking pawl 14 via a further resilient element 58, for example a tension spring, which exerts on the locking pawl 14 a pretensioning acting in the direction of its open position shown in FIG. 1 and on the clamping element 18 a pretensioning acting in the direction of the pivoted position shown in FIG. 1 into a pivoted position shown in FIG. 7. The resilient element 58 is secured to the clamping element 18 at a point 57 and to the locking pawl 14 at a point 59.

The function of the device 10 is described hereinafter more detail with reference to FIGS. 1-7.

As already mentioned, FIG. 1 shows an operating position of the device 10 in which the locking pawl 14 is in its open position, in which the locking pawl 14 releases the fitting part 30.

The locking element 16 and the clamping element 18 are located in their second pivoted position, the locking element 16 being pushed back to a maximum extent with regard to its translational mobility relative to the clamping element 18 in the direction away from the locking pawl 14. The locking element 16 thus bears against the stop 48.

The pin 44 of the restricted guidance 42 bears in this position against an upper end of the slot 46, as is shown in FIG. 1. By means of the slot 46 the pivotability of the locking element 16 is defined relative to the clamping element 18.

In the open position shown in FIG. 1, the clamping element 18 and the locking element 16 secure the open position of the locking pawl 14, by a supporting shoulder 60 being formed on the locking pawl 14, against which the locking element 16 bears with its end 62 facing the locking pawl 14 and the clamping element 18 bears with its end 64 facing the locking pawl 14, supporting the locking pawl 14. In cooperation with the pulling force acting on the clamping element 18 and the locking pawl 14, the open position shown in FIG. 1 is secured by the resilient element 58, the secured open position only being able to be overcome by a torque acting on the locking pawl 14.

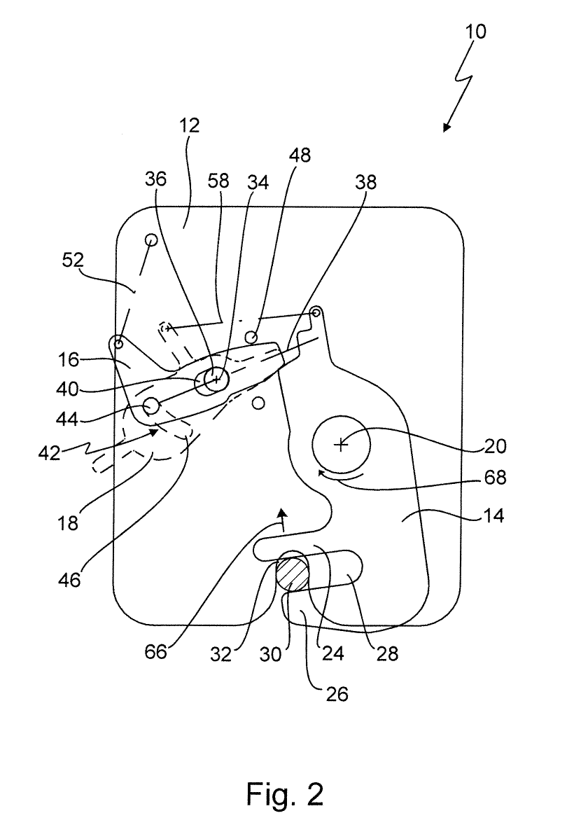

Such a torque is produced when the device 10 is mounted on the fitting part 30, so that the fitting part 30 comes to bear against the locking pawl 14 with the fork limb 24, as is shown in FIG. 2. If the device 10 is mounted, for example, on a vehicle seat, and if the vehicle seat is lowered with the device 10 so that the fitting part 30 is introduced into the recess 32, with the further lowering of the vehicle seat the fitting part 30 exerts a force on the fork limbs 24 according to an arrow 66 in FIG. 2, which effects a pivoting of the locking pawl 14 about the pivot axis 20 in the direction of an arrow 68 in FIG. 2. The supporting shoulder 60 of the locking pawl 14 thus moves away from the ends 62 and 64 of the locking element 16 and/or of the clamping element 18 as is shown in FIG. 2. In the transition from FIG. 1 to FIG. 2, the locking element 16 and the clamping element 18 have not altered their position according to FIG. 1, i.e. they are both still located in the second pivoted position.

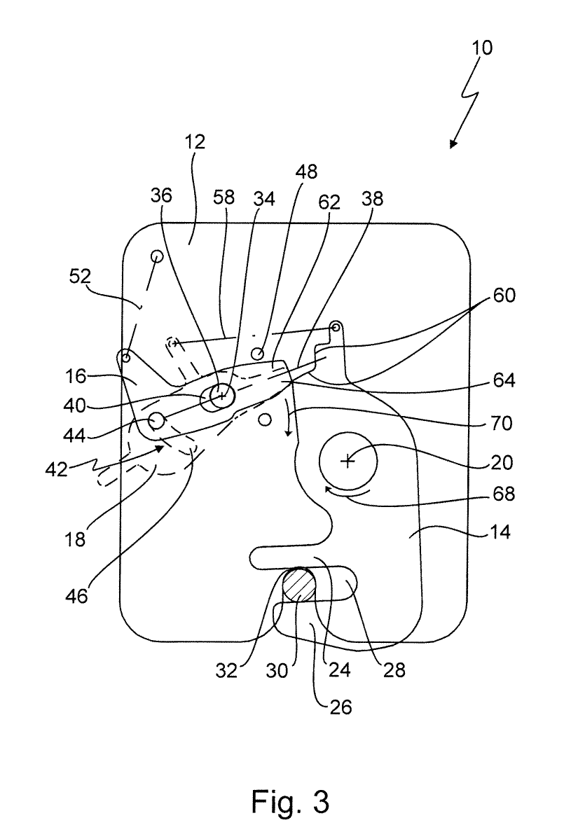

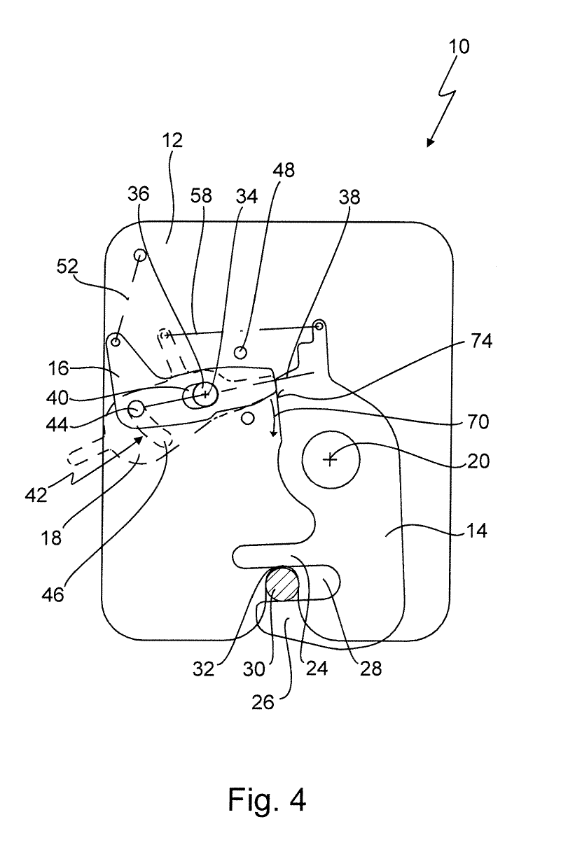

Proceeding from FIG. 2, in FIG. 3 a further operating position of the device 10 is shown, in which by further lowering of the device 10 relative to the fitting part 30 the locking pawl 14 has pivoted one stage further in the direction of the arrow 68 about the pivot axis 20. In this pivoted position of the locking pawl 14, the ends 62 and 64 of the locking element 16 and of the clamping element 18 are released from the supporting shoulder 60 of the locking pawl 14, and by the pulling effect of the resilient element 58 and the pulling effect of the resilient element 52, the locking element 16 and the clamping element 18 together begin to pivot from the second pivoted position in FIGS. 1 and 2 according to an arrow 70 (FIG. 4) about the second pivot axis 34. During this initial pivoting movement, the locking element 16 and the clamping element 18 maintain their relative position to one another.

Further according to FIG. 4, in which the locking pawl 14 is in the same pivoted position as in FIG. 3, the locking element 16 and the clamping element 18 pivot together under the action of the resilient elements 58 and 52 one stage further about the second pivot axis 34, without altering their relative position to one another according to FIGS. 1 to 3. At the same time, a bearing surface 72 at the end 62 of the locking element 16 slides with only slight friction along a bearing surface 74 of the locking pawl 14. The bearing surface 72 which, in a modification of the straight and planar embodiment shown, may be configured in the form of a bead-like point on the locking element 16, which accordingly comes to bear with the bearing surface 74 substantially only in a linear manner, during the pivoting movement from the pivoted position in FIG. 3 into the pivoted position in FIG. 4, does not exert any torque on the locking pawl 14 as might be the case with an eccentric clamping surface according to the prior art.

FIG. 5 shows an operating position of the device 10 in which the locking element 16 and the clamping element 18, by the action of the resilient elements 52 and 58, are pivoted even further in the direction of the arrow 70 in FIG. 4, the locking element 16 now having reached its first pivoted position. The first pivoted position of the locking element 16 is in this case defined by the stop 50, and runs against the locking element 16 during its pivoting movement about the second pivot axis 34. When transferred from the operating position in FIG. 4 into the operating position in FIG. 5, the locking pawl 14 has substantially maintained its pivoted position according to FIGS. 3 and/or 4.

Until reaching the operating position according to FIG. 5, the locking element 16 and the clamping element 18 have not moved relative to one another, but are merely pivoted together about the second pivot axis 34.

The resilient element 52 holds the locking element 16 in abutment against the stop 50.

The bearing surface 72 of the locking element 16 is slid as far as the position in FIG. 5 against the bearing surface 74 of the locking pawl 14 without any noticeable friction.

Proceeding from the operating position in FIG. 5, in which the locking element 16 has reached its first pivoted position, the locking pawl 14 will now being clamped into its closed position.

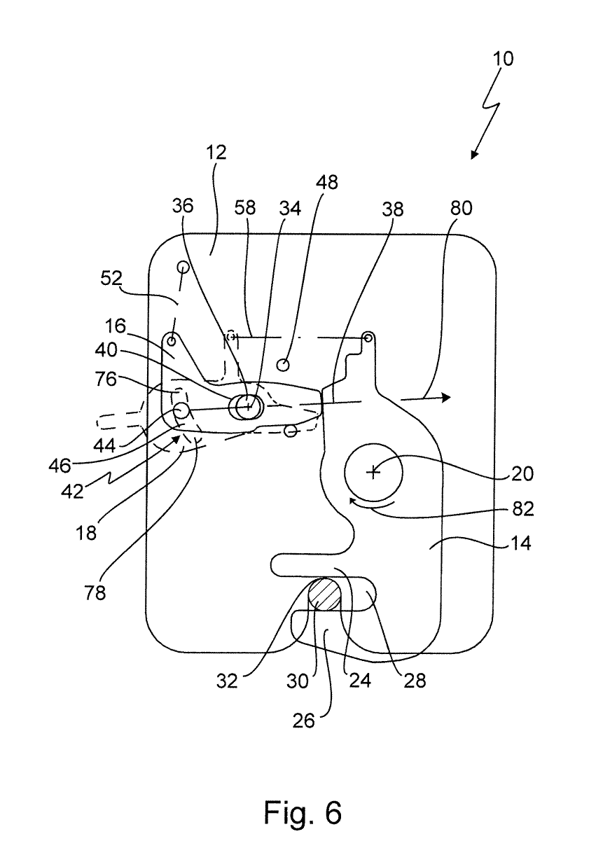

As is shown in FIG. 6, the locking element 16 is hindered by the stop 50 from a further pivoting movement about the second pivot axis 34, whilst the clamping element 18, by the action of the resilient element 58, pivots further about the second pivot axis 34 beyond the first pivoted position. This further pivoting of the clamping element 18 beyond the first pivoted position now effects a translatory movement of the locking element 16 in the direction of the locking pawl 14, which is permitted by the radial play of the locking element 16 relative to the second pivot axis 34 along the straight line 38 and the restricted guidance 42, via which the locking element 16 and the clamping element 18 are coupled.

To this end, the slot 46 of the restricted guidance 42 is eccentrically curved relative to the second pivot axis 34, i.e. a first end 76 of the slot 46 is at a greater distance from the pivot axis 34 than a second end 78 of the slot 46. Between the end 76 and the end 78, the distance from the slot 46 to the pivot axis 34 continuously decreases. As, proceeding from FIG. 5, the clamping element 18 is further pivoted relative to the locking element 16 about the second pivot axis 34, the slot 46 also moves relative to the pin 44, and by the eccentricity of the slot 46 relative to the pivot axis 34 the pin 44 and thus the locking element 16 are moved according to an arrow 80 in a translatory manner against the locking pawl 14, whereby a torque now acts again on the locking pawl 14, which pivots the locking pawl 14 further in the direction of an arrow 82 about the first pivot axis 20.

By the further pivoting of the clamping element 18 about the second pivot axis 34 under the pulling effect of the resilient element 58, as is shown from the transfer from the operating position in FIG. 6 into the operating position in FIG. 7, the clamping element 18 pushes the locking element 16 increasingly against the locking pawl 14 as is illustrated by an arrow 84 in FIG. 7, whereby the locking pawl 14 is pivoted further about the pivot axis 20 (arrow 86) until the locking pawl 14 is clamped into its closed position, in which the lower fork limb 26 of the jaw 28 is now pushed against the fitting part 30. The components of the entire arrangement consisting of the locking element 16, clamping element 18 and locking pawl 14, are clamped against one another in the operating position shown in FIG. 7, whereby rattling noise is avoided during the operation of the vehicle.

The clamping element 18 in the operating position, shown in FIG. 7, blocks a translatory movement oriented away from the locking pawl 14 due to the pulling effect of the resilient element 58 between the clamping element 18 and the locking pawl 14. Moreover, a certain pretensioning between the pin 44 and the slot 46 of the restricted guidance 42 occurs in this operating position.

In the operating position shown in FIG. 7, in which the locking pawl 14 is clamped into its closed position, the bearing surfaces 72 and 74 of the locking element 16 and the locking pawl 14 bear against one another in a self-locking manner. This is effected by the direction of the translatory movement of the locking element 16, as is shown in FIGS. 6 and 7, and thus the clamping force exerted by the locking element 16 on the locking pawl 14 being oriented substantially perpendicular to the bearing surface 74 of the locking pawl 14, against which the locking element 16 bears. The pressure exerted by the locking element 16 on the locking pawl 14 by the translatory movement, which acts in the direction of the straight line 38 which runs through the second pivot axis 34 and also through the pin 44 of the restricted guidance 42, effects a very high degree of self-locking between the bearing surfaces 72 and 74, which also prevents the locking pawl in the event of a vehicle impact from being able to move from its closed position shown in FIG. 7 into the open position shown in FIG. 1.

This high degree of self-locking between the bearing surfaces 72 and 74, however, does not impair the smooth-running of the intentional opening of the device 10, i.e. of the intentional unlocking of the locking pawl 14.

The opening of the device 10 takes place, namely proceeding from FIG. 7, in the reverse manner relative to the closing process disclosed above.

The clamping element 18 thus serves as an actuating element for unlocking the locking pawl 14, for which the clamping element 18 has an actuating lever 88.

If the clamping element 18 is pivoted by a force acting on the actuating lever 88 in the direction of an arrow 90 in FIG. 7, the locking element 16, proceeding from FIG. 7, is initially moved away in a translatory manner from the locking pawl 14, only until the operating position in FIG. 5 is again reached, and a further pivoting of the clamping element 18 in the same pivoting direction, by the pin 44 running against the end 76 of the slot 46, effects a common pivoting movement of the clamping element 18 and of the locking element 16 from the first pivoted position into the second pivoted position shown in FIG. 1 of the locking element 16 and of the clamping element 18, the resilient element 58 then effecting the transfer of the locking pawl 14 into the open position according to FIG. 1.

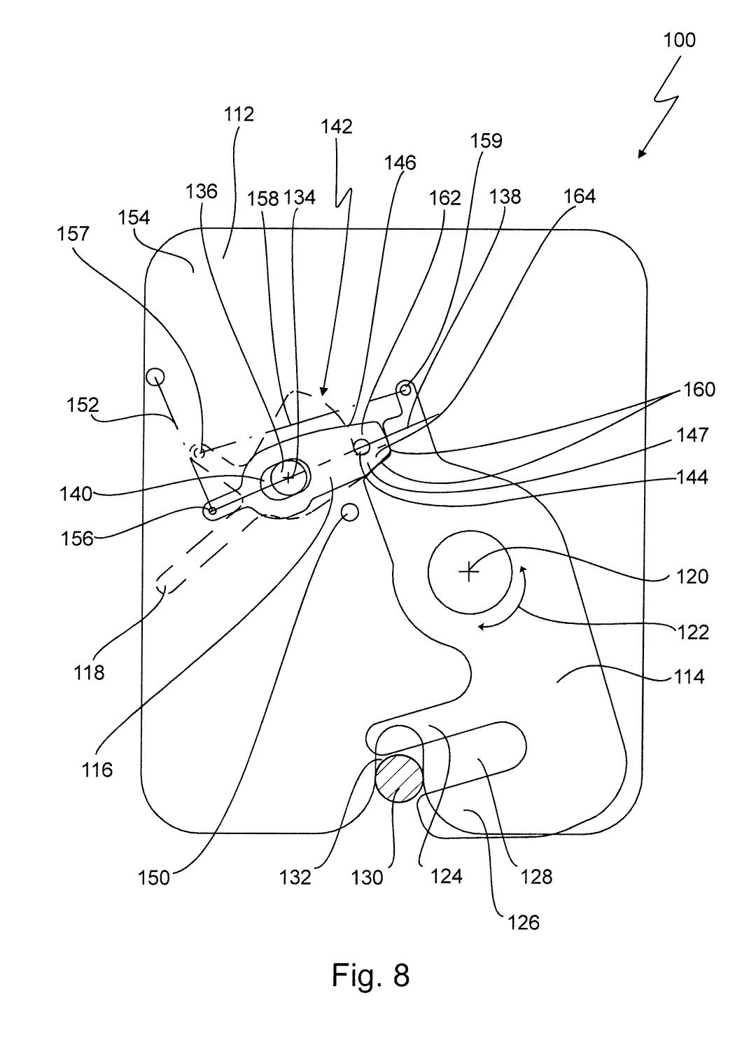

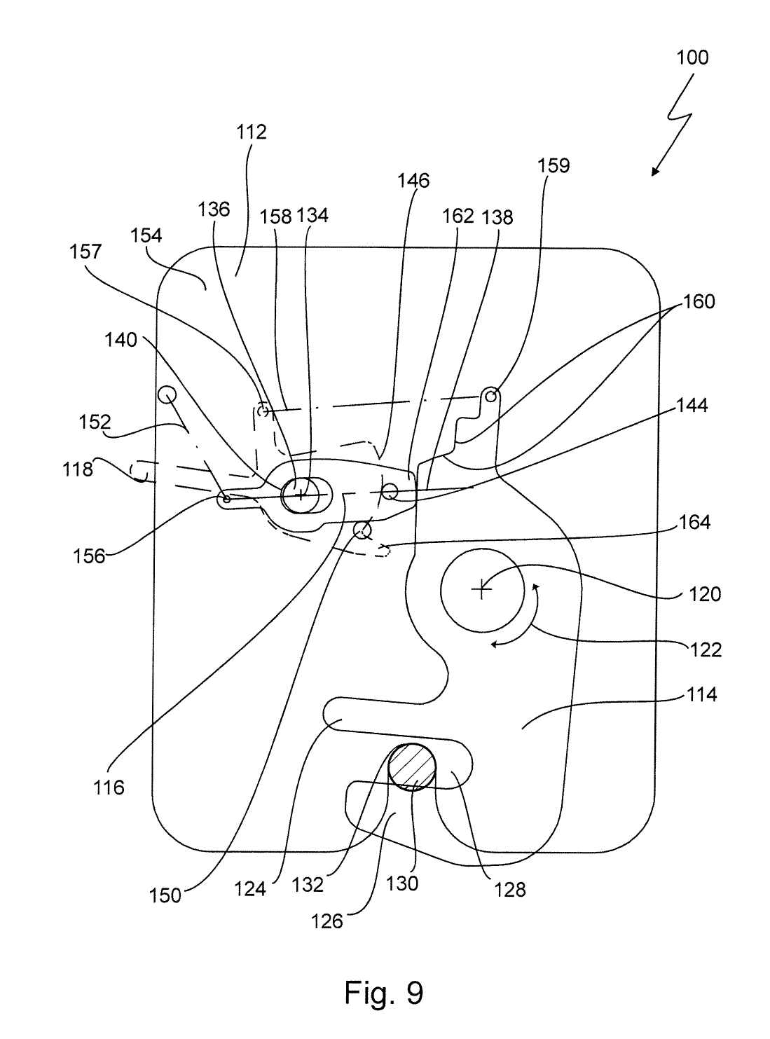

In FIGS. 8 and 9 an embodiment of a device 100 is shown modified relative to the device 10, the same reference numerals having been used as in the device 10, increased by 100, for elements of the device 100 which are identical, similar or comparable in their function to corresponding elements of the device 10.

The device 100 is only shown in two operating positions, and namely in the open position (FIG. 8) and in the closed position (FIG. 9).

Only the differences between the device 100 and the device 10 are disclosed hereinafter.

The device 100 only differs from the device 10 by the structural design of the coupling between the locking element 116 and the clamping element 118, which is used to derive the translators movement of the locking element 116 from the pivoting movement of the clamping element 118.

This aforementioned coupling is implemented by a restricted guidance 142, which instead of the slot 46 of the device 10 has a front face 146 on the clamping element 118 which is eccentrically curved relative to the second pivot axis 134. The restricted guidance 142 further has a pin 144 arranged on the locking element 116, which corresponds to the pin 44 of the device 10. The pin 144 cooperates with the front face 146 in the same manner as the pin 44 cooperates with the slot 46.

Furthermore, in contrast to the restricted guidance 42 of the device 10, the restricted guidance 142 is arranged on the side of the second pivot axis 134 facing the locking pawl 114 at a distance therefrom.

In the open position according to FIG. 1, in which the clamping element 118 and the locking element 116 are in the second pivoted position, the pin 144 is further supported on a projection 147 at one end of the front face 146. This support is maintained as long as the clamping element 118 and the locking element 116 are pivoted together into the first pivoted position, which in the device 100 corresponds to the operating position of the device 10 according to FIG. 5.

The functional principle of the device 100 when transferred from the open position according to FIG. 8 into the closed position according to FIG. 9 is, moreover, identical to the functional principle of the device 10 when transferred from the open position in FIG. 1 into the closed position in FIG. 7, so that reference is made to the above description of the device 10.

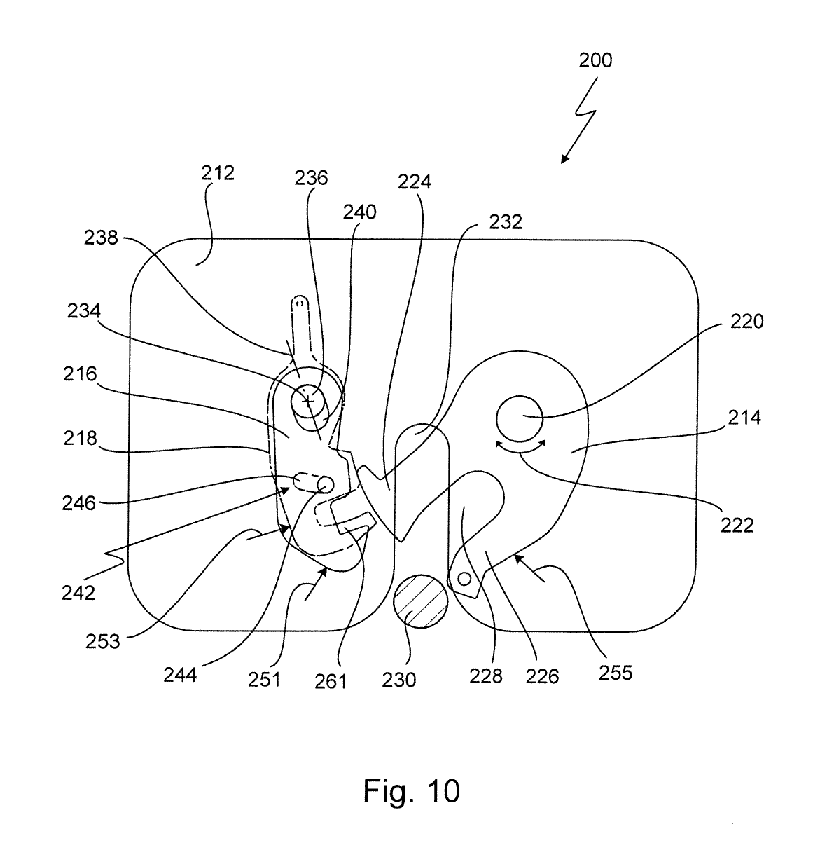

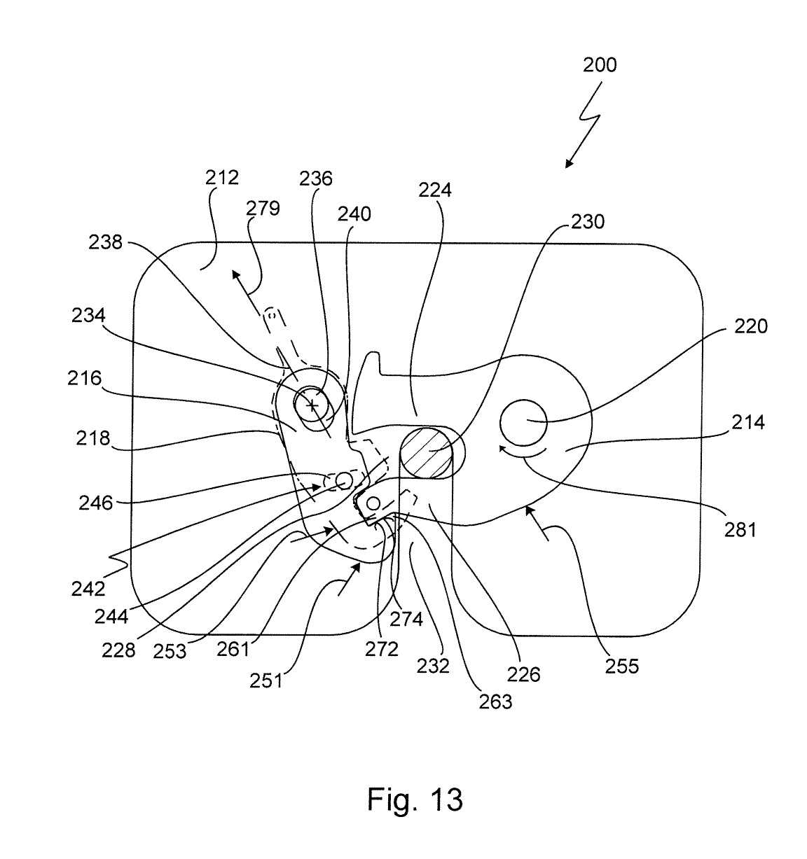

In FIGS. 10 to 14, a further exemplary embodiment is shown of a device provided with the general reference numeral 200 for locking a vehicle seat. The device 200 serves, in particular, for locking a pivotable backrest of a vehicle scat.

For elements of the device 200 which are identical, similar or comparable in their function to corresponding elements of the device 10, the same reference numerals have been used as in the device 10, increased by 200.

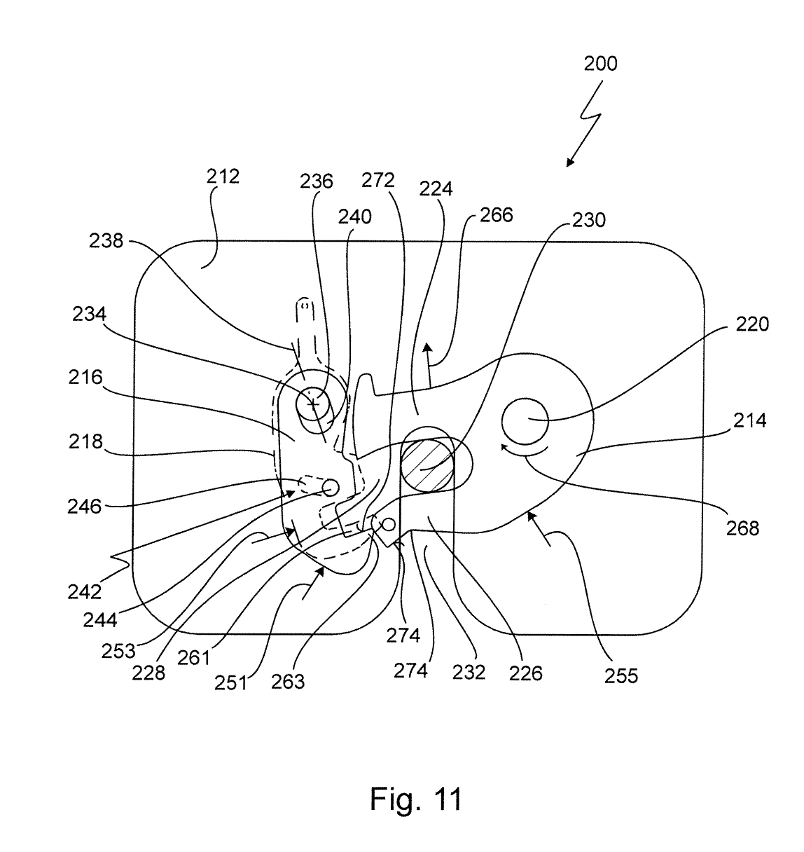

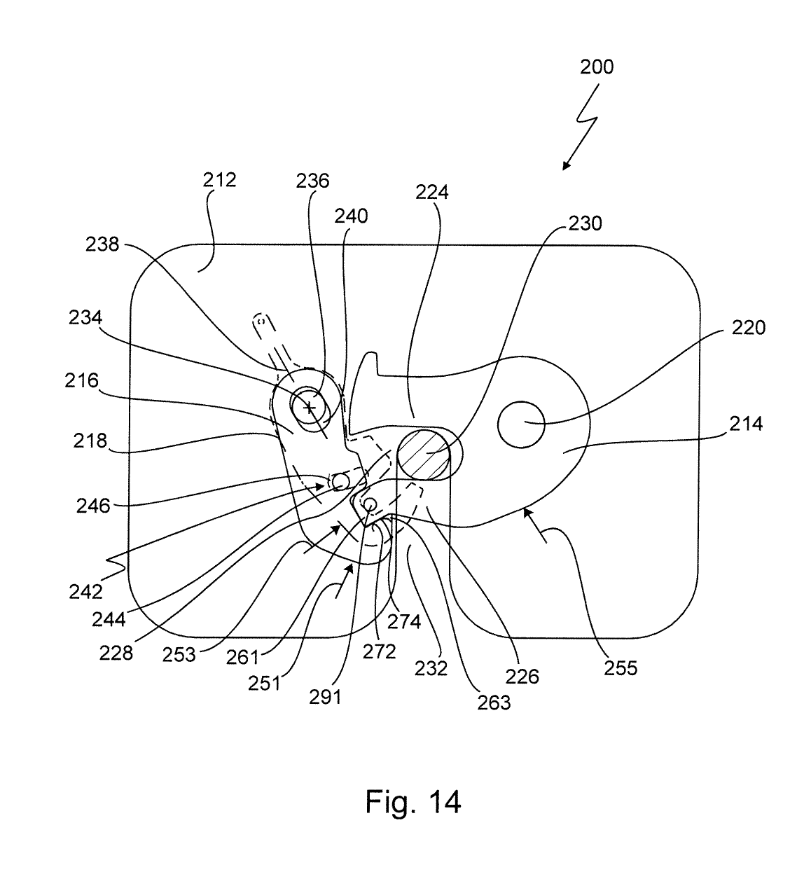

FIG. 10 shows the device 200 in its open position. FIGS. 11 to 14 show the movement sequences when transferring the device 200 from its open position according to FIG. 10 into its clamped closed position according to FIG. 14.

Initially, the individual components of the device 200 are described with reference to FIG. 10.

The device 200 has a housing 212 which is fastened, for example, to the side at the lower end of a backrest of a vehicle seat. On the housing 212 a locking pawl 214, a locking element 216 and a clamping element 218 are secured, the locking pawl 214, the locking element 216 and the clamping element 218 being held relative to the housing 212, in a movable manner on the housing 212.

In order to be able to distinguish more clearly between the locking element 216 and the clamping element 218, the clamping element 218 is shown as in the previous FIGS. 1 to 9 with clotted lines in FIGS. 10 to 14.

The locking pawl 214 is able to be pivoted about a first pivot axis 220 according to a double arrow 222. The pivot axis 220 is fixed to the housing in the same manner as the pivot axis 20 in the device 10.

The locking pawl 214 has a jaw 228 formed between two fork limbs 224 and 226, which is configured for being brought into engagement with a fitting part 230. The fitting part 230 is, for example, a bolt connected fixedly thereto on the lower frame of the vehicle seat. The housing 212 has a recess 232, into which the fitting part 230 may be engaged if the locking device 200 is lowered onto the fitting part 230.

In the open position of the device 200 shown in FIG. 10, the locking pawl 214 is released from the fitting part 230.

The locking element 216 and the clamping element 218 are pivotably mounted about a common second pivot axis 234 fixed to the housing.

Whilst the clamping element 218 is only able to perform pivoting movements about the second pivot axis 234, the locking element 216 may carry out both pivoting movements about the second pivot axis 234, and translatory movements radially to the second pivot axis 234 along a straight line 238. To this end, the locking element 216 is mounted on the axial bearing 236 with radial play, which may be implemented by a slot 240 in the locking element 216, as has already been described with reference to the device 10.

The locking element 216 and the clamping element 218 are coupled to one another via a restricted guidance 242, which has a pin-slot arrangement, comprising a pin 244 which is fixedly connected to the locking element 216, and a slot 246 in the clamping element 218 into which the pin 244 engages.

The restricted guidance 242 is in this exemplary embodiment arranged on the side of the second pivot axis 234 facing the locking pawl 214.

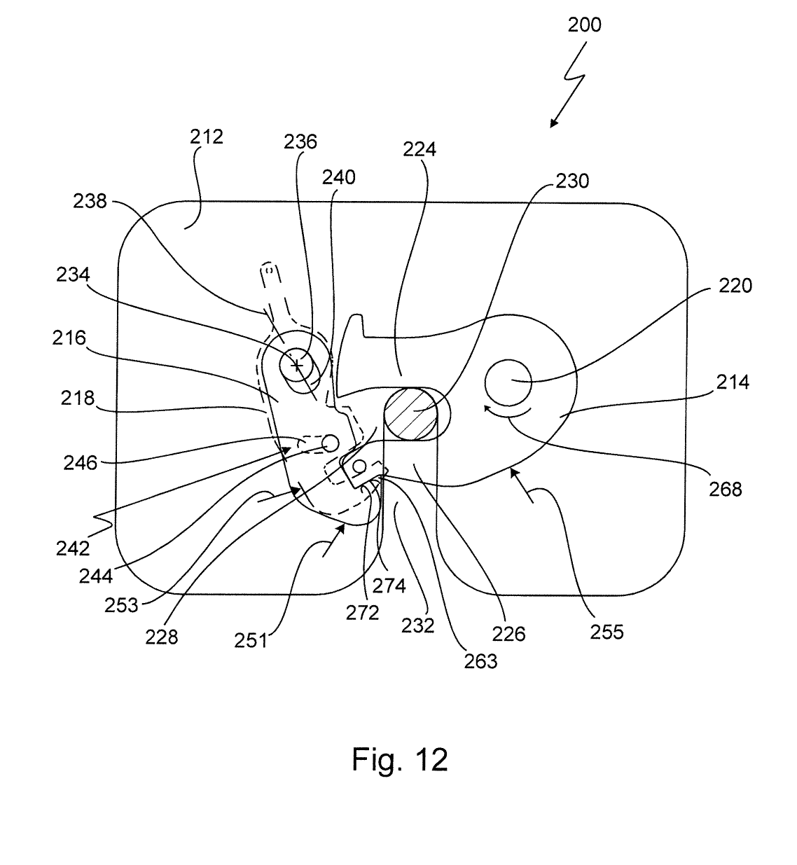

The locking element 216 is pretensioned via resilient element, not shown, and namely from the second pivoted position of the locking element 216 shown in FIG. 10 anti-clockwise in the direction of a first pivoted position of the locking element 216, which is shown in FIGS. 12 to 14. The action of the pretensioning is illustrated in FIG. 10 by an arrow 251. The clamping element 218 is also pretensioned by a resilient element, not shown, according to an arrow 253 in FIG. 10 in the direction of the first pivoted position of the locking element 216.

A further arrow 255 in FIG. 10 shows the direction of action of a further resilient element, not shown, which pretensions the locking pawl 214 into its closed position (FIG. 14) (clockwise).

The function of the device 200 is described in more detail hereinafter with reference to FIGS. 10 to 14.

FIG. 10 shows the device 200 in an operating position, in which the locking pawl 214 is in its open position, in which it releases the fitting part 230.

The locking element 216 and the clamping element 218 are located, therefore, in their second pivoted position, the locking element 216 being displaced forward to a maximum extent with regard to its translatory mobility relative to the clamping element 218 in the direction of the locking pawl 214. Here the device 200 differs from the device 10, in which the locking element 16 in its second pivoted position is pushed back to a maximum extent with regard to its translatory mobility relative to the clamping element 18 in the direction away from the locking pawl 14.

The pin 244 of the restricted guidance 242 bears in this position against one end of the slot 246 facing the locking pawl 214.

If the device 200, proceeding from FIG. 10, is positioned on the fitting part 230, so that the fitting part 230 comes to bear with the fork limb 224 of the locking pawl 214, as is shown in FIG. 11, the fitting part 230 exerts on the locking pawl 214 a force in the direction of an arrow 266, which effects a pivoting of the locking pawl 214 in the direction of an arrow 268 in FIG. 11.

During the pivoting movement of the locking pawl 214, proceeding from FIG. 10, into the pivoted position shown in FIG. 11, the free ends of the fork limbs 224 and 226 slide without any noticeable friction with partial contact past the locking element 216 and the clamping element 218. During the transition from FIG. 10 to FIG. 11, the locking element 216 and the clamping element 218 have not altered their position according to FIG. 10, i.e. they are still both located in the second pivoted position.

With the further lowering of the device 200, proceeding from the operating position in FIG. 11, onto the fitting part 230, the locking pawl 214 pivots one stage further into the pivoted position shown in FIG. 12, the locking element 216 and the clamping element 218 now being pivoted together into the first pivoted position, which is automatically produced under the action of the above-described resilient elements and the pretensioning of the locking element 216 and of the clamping element 218 effected thereby.

As may be seen, in particular, in FIGS. 10 and 11, the locking element 216 has at its end remote from the pivot axis 234 a recess 261 which is defined on one side by a projection 263. The recess 261 defines with the projection 263 a bearing surface 272 of the locking element 216, which comes to bear in the first pivoted position according to FIG. 12 against a bearing surface 274 of the locking pawl 214. The fork limb 226 thus engages in the recess 261, as is shown in FIG. 12. Also in this case, one of the two bearing surfaces 272 or 274 may be reduced to a bead-like projection.

Until reaching the first pivoted position according to FIG. 12, the locking element 216 and the clamping element 218 have not moved relative to one another, but are merely pivoted together about the second pivot axis 234.

Whilst a further pivoting of the locking element 216 via the first pivoted position according to FIG. 12 is avoided by a stop, for example by the fork limb 226 fully engaging in the recess 261 or by the projection 263 of the locking element 216 bearing against an abutment 275 (FIG. 11) on the locking pawl 214, formed in this case by a kink, the clamping element 218 may be further pivoted about the second pivot axis 234, as in the previous exemplary embodiments.

This further pivoting of the clamping element 218 via the first pivoted position of the locking element 216 and relative thereto, now effects a translatory movement of the locking element along the straight line 238 in the direction of an arrow 279, the translatory movement being effected by the radial play of the locking element 216 relative to the pivot axis 234 and by the restricted guidance 242, reference being able to be made relative thereto to the above description of the device 10.

In contrast to the locking element 16, the locking element 216 is pulled back by the pivoting of the clamping element 218 beyond the first pivoted position relative to the clamping element 218.

By the translatory movement of the locking element 216 relative to the clamping element 218, the locking element 216, more specifically the projection 263 of the locking element 216, exerts a pulling force on the locking pawl 214, more precisely on the fork limb 226 of the locking pawl, whereby the locking pawl 214 is pivoted slightly further about the pivot axis 220 in the direction of an arrow 281, whereby the locking pawl 214 is clamped into its closed position according to FIG. 15. The bearing surfaces 272 and 274 thus bear in a self-locking manner against one another.

Whilst the clamping element 18 of the device 10 according to FIGS. 1 to 7 presses the locking element 16 in the first pivoted position in a translatory manner against a region on the locking pawl 14, which is located on the side of the first pivot axis 20 remote from the fitting part 30, the locking element 216 of the device 200 operates in tension, i.e. the locking element 216 exerts on the locking pawl 214 a pulling force, in order to clamp the locking pawl 214 into its closed position. To this end, the clamping element 218 of the locking element 216 moves in the first pivoted position in a translatory manner against a region on the locking pawl 214, which is located on the side of the first pivot axis 220 remote from the fitting part 230.

In other words, in the device 10 the remaining pivoting of the locking pawl 14 for clamping into the closed position is provided by a pushing force or by a pressing force, whilst the remaining pivoting of the locking pawl 214 of the device 200 is provided by a pulling force.

The final pivoted position of the clamping element 218 is defined by a stop 291 on the locking pawl 214, as is shown in FIG. 14.

The clamping element 218 serves, as does the clamping element 18, for unlocking the locking pawl, the unlocking and opening for releasing the fitting part 230 taking place in the reverse sequence of FIG. 14 to FIG. 10.

What is claimed is:

1. A device for locking a vehicle seat, comprising
a locking pawl,
a first pivot axis about which said locking pawl ist pivotable between a closed position and an open position,
a locking element,
a second pivot axis about which said locking element is pivotable between a first pivoted position and a second pivoted position, said locking element being in contact with said locking pawl and clamping said locking pawl into said closed position in said first pivoted position, and said locking element releasing said locking pawl in said second pivoted position so that said locking pawl may adopt said open position, said locking element further being additionally movable in a translatory manner, and
a clamping element associated with said locking element, said clamping element moving said locking element in said first pivoted position of said locking element in said translatory manner increasingly against said locking pawl until said locking pawl is clamped into said closed position.

2. The device of claim 1, wherein said clamping element pushes said locking element in said first pivoted position in said translatory manner against said locking pawl.

3. The device of claim 1, wherein said clamping element pulls said locking element in said first pivoted position in said translatory manner against said locking pawl.

4. The device of claim 1, wherein said locking element is movable in said first pivoted position in said translatory manner in a direction which runs substantially perpendicular to a bearing surface of said locking pawl against which said locking element bears in said first pivoted position.

5. The device of claim 1, wherein said locking element bears in a self-locking manner against said locking pawl in said closed position of said locking pawl.

6. The device of claim 1, wherein said clamping element is also pivotable about said second pivot axis, said clamping element, proceeding from said second pivoted position as far as said first pivoted position of said locking element, being pivotable substantially together with said locking element, and a further pivoting of said clamping element beyond said first pivoted position is converted into said translatory movement of said locking element.

7. The device of claim 1, wherein a stop is present for said locking element which prevents a further pivoting of said locking element beyond said first pivoted position.

8. The device of claim 1, wherein in said first pivoted position said locking element is movable radially relative to said second pivot axis in said translatory manner.

9. The device of claim 1, wherein an axial bearing defining said second pivot axis is associated with both said locking element and said clamping element, and wherein said locking element is mounted on said axial bearing with radial play along a straight line.

10. The device of claim 1, wherein said locking element and said clamping element are coupled together via a restricted guidance, which permits a defined pivoting movement of said locking element and said translatory movement of said locking element relative to said clamping element.

11. The device of claim 10, wherein said restricted guidance has a pin-slot arrangement having a pin and a slot, said slot being curved eccentrically relative to said second pivot axis.

12. The device of claim 11, wherein said pin-slot arrangement is arranged on a side of said second pivot axis remote from said locking pawl at a distance from said second pivot axis.

13. The device of claim 11, wherein said pin-slot arrangement is arranged on a side of said second pivot axis facing said locking pawl at a distance from said second pivot axis.

14. The device of claim 10, wherein said restricted guidance has an arrangement consisting of a front face of said clamping element which is eccentrically curved relative to said second pivot axis and a pin arranged on said locking element.

15. The device of claim 14, wherein said restricted guidance is arranged on a side of said second pivot axis facing said locking pawl at a distance from said second pivot axis.

16. The device of claim 1, wherein said clamping element is connected to said locking pawl via a resilient element, which exerts on said locking pawl a pretensioning acting in direction towards said open position and a pretensioning acting on said clamping element in direction towards said first pivoted position.

17. The device of claim 1, wherein said locking element is pretensioned in direction of said first pivoted position.

18. The device of claim 1, wherein at least one of said locking element and said clamping element secure said open position of said locking pawl in said second pivoted position.

19. The device of claim 1, wherein said clamping element is configured as an actuating element for unlocking said locking pawl.
